(19) United States
(12) Patent Application Publication
(10) Pub. No.: US 2024/0413867 A1
(43) Pub. Date: Dec. 12, 2024

(54) CHANNEL STATE FEEDBACK WITH FRACTIONAL RANK INDICATOR

(71) Applicant: QUALCOMM Incorporated, San Diego, CA (US)

(72) Inventors: Chenxi HAO, Beijing (CN); Yuwei REN, Beijing (CN); Wei XI, Beijing (CN); Rui HU, Beijing (CN); Yu ZHANG, San Diego, CA (US); Taesang YOO, San Diego, CA (US); Hao XU, Beijing (CN)

(21) Appl. No.: 18/695,678

(22) PCT Filed: Nov. 18, 2021
(86) PCT No.: PCT/CN2021/131406

§ 371 Date: Mar. 26, 2024

(51) Int. Cl. H04B 7/06

(52) U.S. Cl. CPC H04B 7/0626; H04B 7/063

(57) ABSTRACT

Certain aspects of the present disclosure provide techniques for reporting channel state information (CSI). According to certain aspects, a method for wireless communications by a user equipment (UE) generally includes generating channel state information (CSI) comprising a (at least one) fractional rank indication (RI) value for a set of candidate ranks, a first indication of a first layer or first singular vector, and a second indication of a second layer or second singular vector and transmitting the CSI to a network entity.

### INTRODUCTION

Aspects of the present disclosure relate to wireless communications, and more particularly, to techniques for signaling channel state feedback (CSF).

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communication networks to overcome various challenges.

### SUMMARY

One aspect provides a method for wireless communications by a user equipment (UE). The method generally includes generating channel state information (CSI) comprising a fractional rank indication (RI) value for a set of candidate ranks, a first indication of a first layer or first singular vector, and a second indication of a second layer or second singular vector and transmitting the CSI to a network entity.

One aspect provides a method for wireless communications by a network entity. The method generally includes receiving, from a user equipment (UE), channel state information (CSI) comprising a fractional rank indication (RI) value for a set of candidate ranks, a first indication of a first layer or first singular vector, and a second indication of a second layer or second singular vector and obtaining a precoding matrix indicator (PMI) based on the first indication, the second indication, and weights or probabilities determined based on the fractional RI value.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A-3D depict various example aspects of data structures for a wireless communication network.

FIG. 4 illustrates a conceptual example of precoder matrices.

FIG. 5 is a block diagram illustrating an example of codebook based CSF.

FIG. 6A and FIG. 6B are block diagrams illustrating examples of codebook based CSF.

FIG. 7A, FIG. 7B, and FIG. 7C are block diagrams illustrating examples of CSF reporting for codebook based CSF.

FIG. 8 is a block diagram illustrating an example of machine learning (ML) based CSF.

FIG. 9A and FIG. 9B are block diagrams illustrating examples of CSF reporting for ML based CSF.

FIG. 10A and FIG. 10B are block diagrams illustrating examples of ML based CSF and corresponding reporting.

FIG. 11 is a call flow diagram illustrating an example of CSF reporting, according to aspects of the present disclosure.

FIG. 12A and FIG. 12B are block diagrams illustrating examples of CSF and corresponding reporting, according to aspects of the present disclosure.

FIG. 13 is a block diagram illustrating an example of CSF reporting, according to aspects of the present disclosure.

FIG. 14 is a flow diagram illustrating example operations for wireless communication by a user equipment (UE), according to aspects of the present disclosure.

FIG. 15 is a flow diagram illustrating example operations for wireless communication by a transmit node, according to aspects of the present disclosure.

FIG. 16 depicts aspects of an example communication device.

FIG. 17 depicts aspects of an example communication device.

### DETAILED DESCRIPTION

Aspects of the present disclosure relate to wireless communications, and more particularly, to techniques for channel state feedback (CSF) reporting and processing.

Artificial intelligence (AI) and machine learning (ML) techniques have been considered as a way to aid communication systems. One example is AI-based techniques for channel state feedback (CSF) reporting from a user equipment (UE) to a base station (e.g., a gNB). In some cases, AI-based techniques may be applied for explicit channel state information (CSI) reporting. In other cases, AI-based techniques may be applied to report a desired precoder and rank via a precoding matrix indicator (PMI) and rank indicator (RI). The rank (of the channel matrix) defines the number of linearly independent rows or columns in a transmission matrix H and generally indicates how many independent data streams (or layers) can be transmitted simultaneously.

Aspects of the present disclosure propose a design with a PMI/RI encoder at the user equipment (UE) side with two separate encoders. One encoder may take channel measurements as input and may output information sequences for different layers. The other encoder may take channel measurements or CSI-RS received signal as input and output information about rank. In general, a rank encoder acts as a classifier, with its output what may be referred to as a soft RI, indicating the probability of each candidate rank or the probability of each candidate layer, rather than a hard-decision of a particular rank. Further, the quantization resolution for each layer may also depend on the their corresponding probability. In some other cases, there may be a single encoder, at the UE side, that takes channel measurements or CSI-RS received signal as input and outputs the information about PMI and rank together. In this case, the output rank may be referred to as a soft RI, indicating the probability of each candidate rank or the probability of each candidate layer, rather than a hard-decision of a particular rank.

Aspects of the present disclosure provide for efficient and adaptive reporting payload, based on the probability of each rank candidate (e.g., the soft rank or fractional rank indicator (RI) as different candidate ranks may receive a fraction of the total probability of 1). For example, the techniques may allow for efficient and flexible reporting of transmission covariance informations, such as singular vectors and singular values, which can be conveyed by the layer-reporting and fractional rank. Aspects of the present disclosure may also allow for adaptive quantization for CSF, based on fractional RI, resulting in more flexible and efficient resource usage for CSF reporting.

### Introduction to Wireless Communication Networks

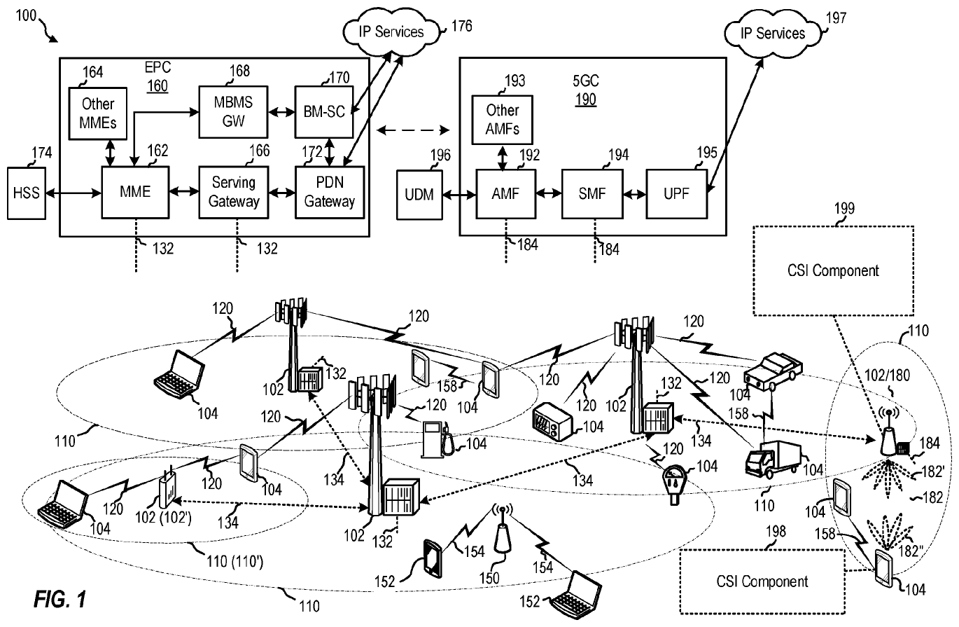

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes CSI Component 199, which may be configured to participate in a CSF procedure. Wireless network 100 further includes CSI Component 198, which may be used configured to participate in a CSF procedure.

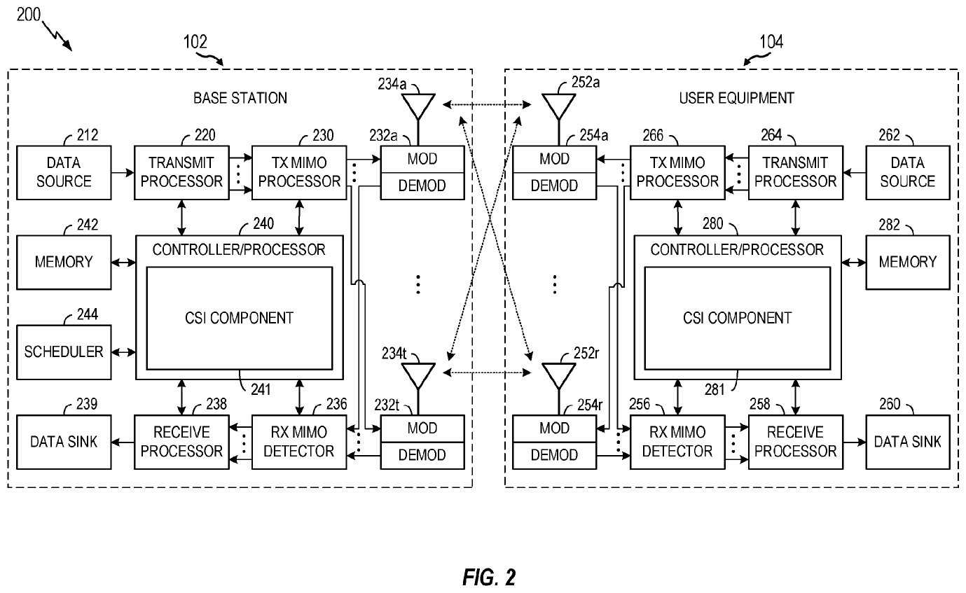

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes CSI Component 241, which may be representative of CSI Component 199 of FIG. 1. Notably, while depicted as an aspect of controller/processor 240, CSI Component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes CSI Component 281, which may be representative of CSI Component 198 of FIG. 1. Notably, while depicted as an aspect of controller/processor 280, CSI Component 281 may be implemented additionally or alternatively in various other aspects of user equipment 104 in other implementations.

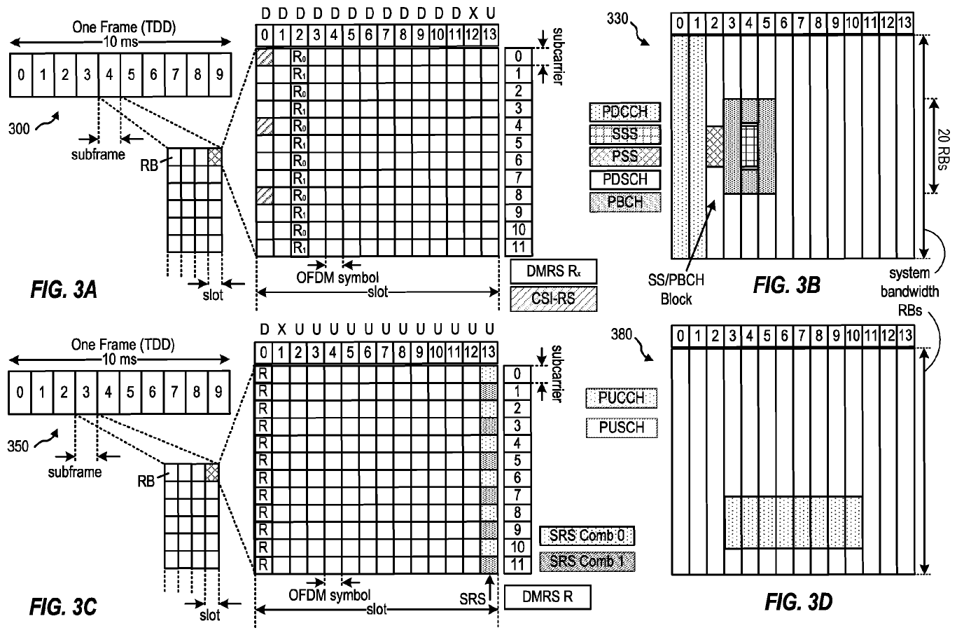

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

### Example CSI Report Configuration

Channel state information (CSI) may refer to channel properties of a communication link. The CSI may represent the combined effects of, for example, scattering, fading, and power decay with distance between a transmitter and a receiver. Channel estimation using pilots, such as CSI reference signals (CSI-RS), may be performed to determine these effects on the channel. CSI may be used to adapt transmissions based on the current channel conditions, which is useful for achieving reliable communication, in particular, with high data rates in multi-antenna systems. CSI is typically measured at the receiver, quantized, and fed back to the transmitter.

The time and frequency resources that can be used by a user equipment (UE) to report CSI are controlled by a base station (BS) (e.g., gNB). CSI may include channel quality indicator (CQI), precoding matrix indicator (PMI), CSI-RS resource indicator (CRI), SS/PBCH Block Resource indicator (SSBRI), layer indicator (LI), rank indicator (RI) and/or L1-RSRP. However, as described below, additional or other information may be included in the report.

A UE may be configured by a BS for CSI reporting. The BS may configure UEs for the CSI reporting. For example, the BS configures the UE with a CSI report configuration or with multiple CSI report configurations. The CSI report configuration may be provided to the UE via higher layer signaling, such as radio resource control (RRC) signaling (e.g., CSI-ReportConfig). The CSI report configuration may be associated with CSI-RS resources for channel measurement (CM), interference measurement (IM), or both. The CSI report configuration configures CSI-RS resources for measurement (e.g., CSI-ResourceConfig). The CSI-RS resources provide the UE with the configuration of CSI-RS ports, or CSI-RS port groups, mapped to time and frequency resources (e.g., resource elements (REs)). CSI-RS resources can be zero power (ZP) or non-zero power (NZP) resources. At least one NZP CSI-RS resource may be configured for CM.

For the Type II codebook, the PMI is a linear combination of beams; it has a subset of orthogonal beams to be used for linear combination and has per layer, per polarization, amplitude and phase for each beam. For the PMI of any type, there can be wideband (WB) PMI and/or subband (SB) PMI as configured.

The CSI report configuration may configure the UE for aperiodic, periodic, or semi-persistent CSI reporting. For periodic CSI, the UE may be configured with periodic CSI-RS resources. Periodic CSI on physical uplink control channel (PUCCH) may be triggered via RRC. Semi-persistent CSI reporting on physical uplink control channel (PUCCH) may be activated via a medium access control (MAC) control element (CE). For aperiodic and semi-persistent CSI on the physical uplink shared channel (PUSCH), the BS may signal the UE a CSI report trigger indicating for the UE to send a CSI report for one or more CSI-RS resources, or configuring the CSI-RS report trigger state (e.g., CSI-AperiodicTriggerStateList and CSI-SemiPersistentOnPUSCH-TriggerStateList). The CSI report trigger for aperiodic CSI and semi-persistent CSI on PUSCH may be provided via downlink control information (DCI).

The UE may report the CSI feedback (CSF) based on the CSI report configuration and the CSI report trigger. For example, the UE may measure the channel on which the triggered CSI-RS resources (associated with the CSI report configuration) is conveyed. Based on the measurements, the UE may select a preferred CSI-RS resource. The UE reports the CSF for the selected CSI-RS resource. LI may be calculated conditioned on the reported CQI, PMI, RI and CRI; CQI may be calculated conditioned on the reported PMI, RI and CRI; PMI may be calculated conditioned on the reported RI and CRI; and RI may be calculated conditioned on the reported CRI.

Each CSI report configuration may be associated with a single downlink (DL) bandwidth part (BWP). The CSI report setting configuration may define a CSI reporting band as a subset of subbands of the BWP. The associated DL BWP may indicated by a higher layer parameter (e.g., bwp-Id) in the CSI report configuration for channel measurement and contains parameter(s) for one CSI reporting band, such as codebook configuration, time-domain behavior, frequency granularity for CSI, measurement restriction configurations, and the CSI-related quantities to be reported by the UE. Each CSI resource setting may be located in the DL BWP identified by the higher layer parameter, and all CSI resource settings may be linked to a CSI report setting have the same DL BWP.

In certain systems, the UE can be configured via higher layer signaling (e.g., in the CSI report configuration) with one out of two possible subband sizes (e.g., reportFreqConfiguration contained in a CSI-ReportConfig) which indicates a frequency granularity of the CSI report, where a subband may be defined as N_{PRB}^{SB} contiguous physical resource blocks (PRBs) and depends on the total number of PRBs in the bandwidth part. The UE may further receive an indication of the subbands for which the CSI feedback is requested. In some examples, a subband mask is configured for the requested subbands for CSI reporting. The UE computes precoders for each requested subband and finds the PMI that matches the computed precoder on each of the subbands.

### Compressed CSI Feedback Coefficient Reporting

As discussed above, a user equipment (UE) may be configured for channel state information (CSI) reporting, for example, by receiving a CSI configuration message from the base station. In certain systems (e.g., 3GPP Release 15 5G NR), the UE may be configured to report at least a Type II precoder across configured frequency domain (FD) units. For example, the precoder matrix W for layer r includes the W₁ matrix, reporting a subest of selected beams using spatial compression and the W_{2,r} matrix, reporting (for cross-polarization) the linear combination coefficients for the selected beams (2L) across the configured FD units:

$${W}_{r} = {\sum }_{i = 0}^{2 L - 1} {b}_{i} \cdot {c}_{i} , where {c}_{i} = [ {\underbrace{{c}_{i , 0} … {c}_{i , {N}_{3} - 1}}}_{{N}_{3}} ] ,$$

where b; is the selected beam, c; is the set of linear combination coefficients (i.e., entries of W_{2,r} matrix), L is the number of selected spatial beams, and N₃ corresponds to the number of frequency units (e.g., subbands, resource blocks (RBs), etc.). In certain configurations, L is RRC configured. The precoder is based on a linear combination of digital Fourier transform (DFT) beams. The Type II codebook may improve MU-MIMO performance. In some configurations considering there are two polarizations, the W_{2,r} matrix has size 2L×N₃.

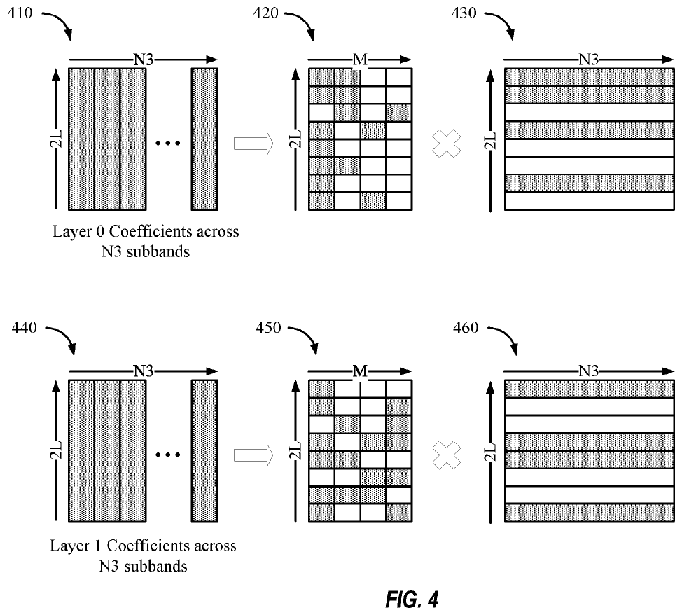

In certain systems (e.g., Rel-16 5G NR), the UE may be configured to report FD compressed precoder feedback to reduce overhead of the CSI report. As shown in FIG. 4, the precoder matrix (W_{2,i}) for layer i with i=0.1 may use an FD compression W_{f,i}^{H} matrix to compress the precoder matrix into \tilde{W}_{2,i} matrix size to 2L×M (where M is network configured and communicated in the CSI configuration message via RRC or DCI, and M<N₃) given as:

$${W}_{i} = {W}_{1} {\tilde{W}}_{2 , i} {W}_{f , i}^{H}$$

Where the precoder matrix Wᵢ (not shown) has P=2N₁N₂ rows (spatial domain, number of ports) and N₃ columns (frequency-domain compression unit containing RBs or reporting sub-bands), and where M bases are selected for each of layer 0 and layer 1 independently. The \tilde{W}_{2,0} matrix 420 consists of the linear combination coefficients (amplitude and co-phasing), where each element represents the coefficient of a tap for a beam. The \tilde{W}_{2,0} matrix 420 as shown is defined by size 2L×M, where one row corresponds to one spatial beam in W₁ (not shown) of size P×2L (where L is network configured via RRC), and one entry therein represents the coefficient of one tap for this spatial beam. The UE may be configured to report (e.g., CSI report) a subset K₀<2LM of the linear combination coefficients of the W_{2,0} matrix 420. For example, the UE may report K_{NZ,i}<K₀ coefficients (where K_{NZ,i} corresponds to a maximum number of non-zero coefficients for layer-i with i=0 or 1, and K₀ is network configured via RRC) illustrated as shaded squares (unreported coefficients are set to zero). In some configurations, an entry in the \tilde{W}_{2,0} matrix 420 corresponds to a row of W_{f,0}^{H} matrix 430. In the example shown, both the \tilde{W}_{2,0} matrix 420 at layer 0 and the \tilde{W}_{2,0} matrix 450 at layer 1 are 2L×M.

The W_{f,0}^{H} matrix 430 is composed of the basis vectors (each row is a basis vector) used to perform compression in frequency domain. In the example shown, both the W_{f,0}^{H} matrix 430 at layer 0 and the W_{f,1}^{H} matrix 460 at layer 1 include M=4 FD basis (illustrated as shaded rows) from N₃ candidate DFT basis. In some configurations, the UE may report a subset of selected basis of the W_{f,i}^{H} matrix via CSI report. The M bases specifically selected at layer 0 and layer 1. That is, the M bases selected at layer 0 can be same/partially-overlapped/non-overlapped with the M bases selected at layer 1.

### Overview of UE PMI Codebook-Based CSF

A PMI codebook generally refers to a dictionary of PMI entries. In this way, using a PMI codebook, each PMI component from a pre-defined set can be mapped to bit-sequences reported by a UE. A based station receiving the bit-sequence (as CSF) can then obtain the corresponding PMI from the reported bit-sequence.

How the UE calculates PMI may be left to UE implementation. However, how the UE reports the PMI should follow a format defined in the codebook, so the UE and base station each know how to map PMI components to reported bit-sequences.

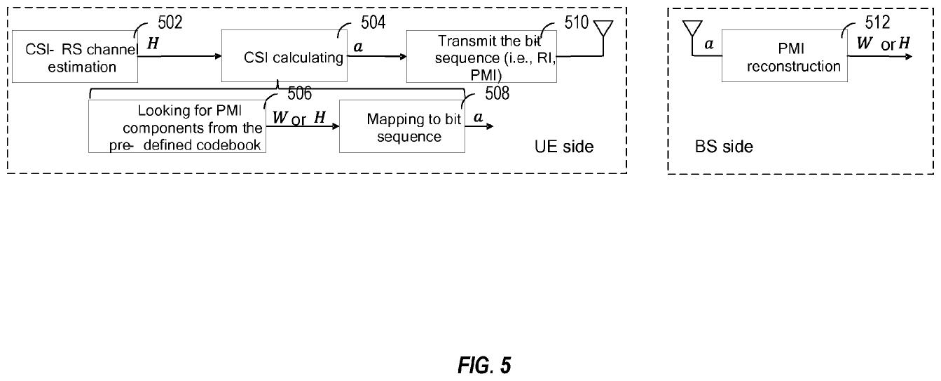

FIG. 5 is a block diagram illustrating an example of codebook based CSF. As illustrated, the UE may first perform channel estimation (at 502) based on CSI-RS to estimate channel H. A CSI calculating block 504 may generate a bit sequence a. As illustrated, bit sequence a may be generated looking for PMI components from the pre-defined PMI codebook for radio channel H or precoder W (at block 506) and mapping the PMI components to the bit sequence a, via block 508. This mapping, from a set of predefined PMI components essentially acts as a form of quantization. The UE transmits the bit sequence a to the BS (e.g., in a CSI report), via block 510.

As illustrated in FIG. 5, at the BS side, the BS receives the bit sequence a reported by the UE. The BS then follows the codebook to obtain each PMI component using the reported bit-sequence a and reconstructs the actual PMI, at block 512, using each PMI component (obtained from the codebook), to recover the radio channel H or precoder W.

The particular PMI components reported by the UE (via mapping to the bit sequence a) may vary according to CSF type.

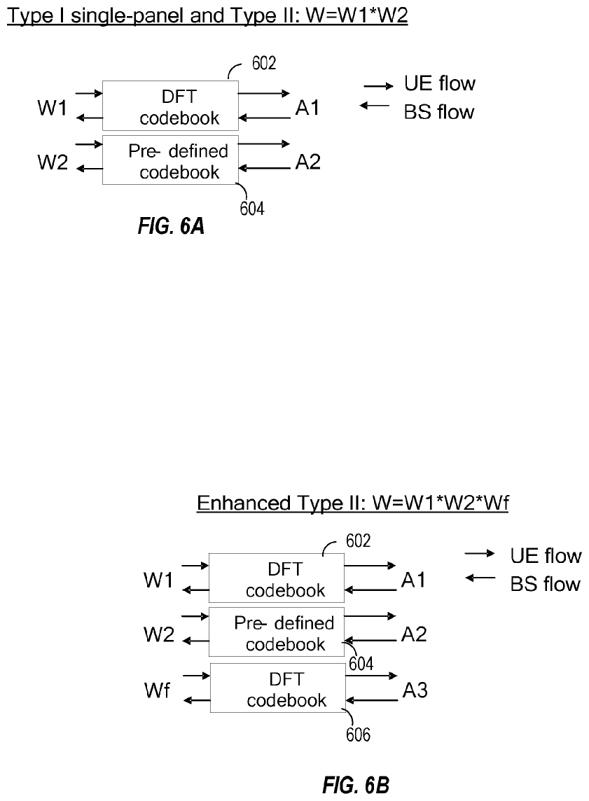

For example, as illustrated in FIG. 6A, for Type I single-panel and Type II CSF, the PMI components may correspond to the W1 and W2 matrices noted above, wherein W is the product of W1 and W2 (W=W1*W2). As illustrated, the UE may generate bit sequence A1, based on W1, from a first (DFT) codebook 602, and generate a bit sequence A2, based on W2, from a second (pre-defined) codebook 604. Bit sequences A1 and A2 may be included (or encoded) in bit sequence a. At the BS side, the BS will use A1 and A2 to retrieve W1 and W2 from the corresponding codebooks, in order to reconstruct W.

As illustrated in FIG. 6B, for an enhanced Type II CSB, the PMI components may also include the frequency domain (FD) compression matrix Wf, where W=W1*W2*Wf. As illustrated, in addition to bit sequences A1 and A2, for enhanced Type II CSB the UE may generate a third bit sequence A3, based on Wf, from a third (DFT) codebook 606. Bit sequences A1 and A2 may be included (or encoded) in bit sequence a. At the BS side, the BS will use A1, A2, and A3 to retrieve W1, W2, and Wf from the corresponding codebooks, in order to reconstruct W.

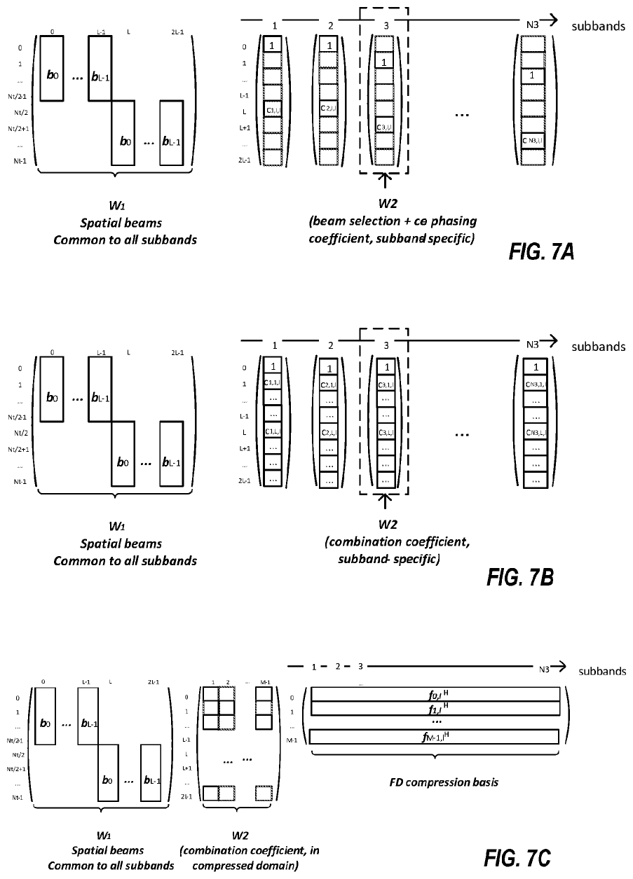

As illustrated in FIG. 7A, for a Type I codebook, W1 may represent select spatial beams, from a set of spatial beams, common to all subbands, while W2 may have columns that essentially perform single beam selection with cross-polarization coefficients for subband-specific precoding (e.g., with just one non-zero coefficient to combine the beam on polarization 1 and 2). In some cases, as illustrated in FIG. 7B for Type II codebook, W2 may have (non-zero) coefficients for each beam, rather than just performing a single beam selection. FIG. 7C illustrates an example, for an Enhanced Type II codebook, of W2 compressed in the frequency domain, based on FD compression bases in Wf.

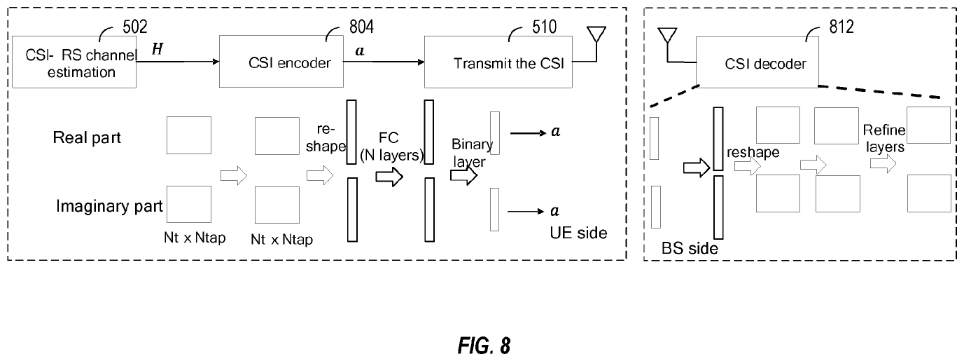

As noted above, AI/ML may be deployed for CSI reporting. FIG. 8 is a block diagram illustrating an example processing flow of ML-based CSF. When compared to the example diagram shown in FIG. 5, for ML-based CSF, the CSI calculating block (504) at the UE side may be replaced by a CSI encode 804. Similarly, at the BS-side, the PMI reconstruction block 512 may be replaced by a CSI decoder 812.

In general, CSI encoder 804 and CSI decoder 812 may be implemented using any suitable AI/ML processing, such as neural networks having convolutional layers and/or fully/partially-connected layers (M convolutional layers and N fully/partially-connected layers are shown in the illustrated example). In such cases, each layer may have a number of neurons and the output of one layer may be multiplied with a weight, adjusted with a bias, and input to the next layer. An activation function may be applied to each neuron to generate the output, with the final output being the bit sequence a. The CSI encoder 804 and CSI decoder 812 may be jointly optimized and jointly trained, to ensure the neural networks derived for the CSI decoder 812 are able to properly recover the CSI from the bit sequence a.

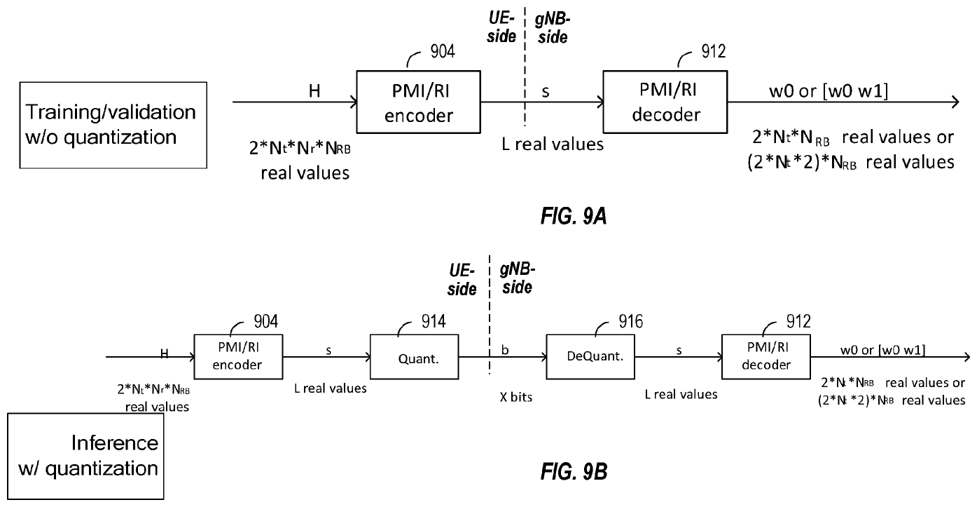

FIGS. 9A and 9B illustrate a first ML-based CSF reporting scheme that utilizes an encoder 904 for joint PMI/RI calculation at the UE side and a decoder 912 for joint PMI/RE (re)construction at the BS side. For the example shown in FIG. 9A, training and validation is performed without quantization, such that the output of the encoder 904 at the UE side is L real values represented by s. At the BS-side, the decoder 912 takes s and recovers W0 or W0 and W1, via a hard decision.

For the example shown in FIG. 9B, at the UE-side quantization is performed on s, at block 914, such that a quantized value b represented by X bits is output. On the BS-side, dequantization is performed, at block 916, to obtain s′ representing L real values, prior to decoding. In these examples, the CSI payload size does not vary with different RI.

The training of the encoder 904 and decoder 912 may be performed, such that, given the L real values (s) generated by the encoder 904 (or quantized values b), the decoder 912 is able to recover the same CSI (e.g., corresponding w0 and/or w1) corresponding to the input used at the decoder 912.

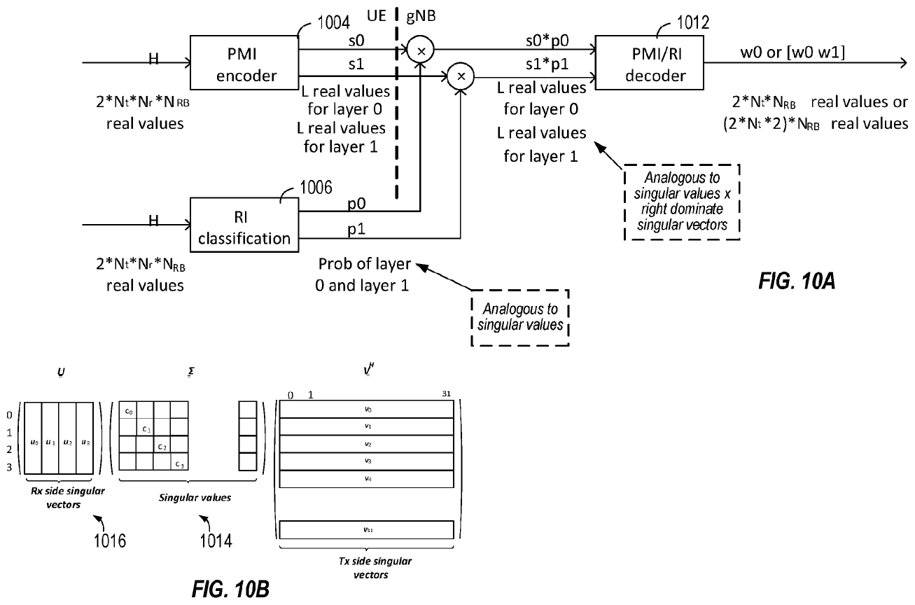

FIG. 10A illustrates a second ML-based CSF reporting scheme that utilizes a separate PMI encoder 1004 and RI classification block 1006. In this case, the PMI encoder 1004 generates L real values for each layer (e.g., s0 for layer 0 and s1 layer 1). The RI classification block 1006 may generate a “soft” RI indication, meaning an output that indicates a probability for each layer (e.g., p0 for layer 0 and p 1 for layer 1) or rank. While not shown in this example, quantization may also be performed on the output of the PMI encoder 1004 and/or RI classification block 1006. At the BS-side, a joint PMI/RI decoder 1012 takes the layer values and applies the probabilities (s0*p0, s1*p) to recover W0 or W0 and W1, via a hard decision.

As noted in FIG. 10A, the probability for each layer (p0 and p1) may be considered analogous to singular values 1014 shown in FIG. 10B reported in non-AI based CSF reporting. Similarly, the products s0*p0, s1*p may be considered analogous to the product of singular values 1014 and right dominate singular vectors 1016. In this sense, reporting the soft RI can be regarded as reporting of singular values c0, c1 . . . etc, and the reported PMI is reporting of each singular vectors v0, v1, v2, v3. With this information, the gNB is able to obtain the transmit side covariance information, e.g., [c0*v0, c*v1, . . . ]. This kind of covariance reporting can be regarded as a case of explicit CSI feedback.

### Example Fractional RI Reporting and Adaptive Quantization

Aspects of the present disclosure generally provide signaling mechanisms to efficiently convey soft RI values for each layer in the air interface between a UE and gNB, as a fractional RI value with information for each layer. The signaling mechanisms may also adapt quantization of each layer, for example, with the quantization resolution of each layer determined based on the factional rank. At the gNB side, the final PMI may be obtained based on the product of the weight of each layer and the corresponding layer, wherein the weight of each layer is determined by the fractional rank. In some other cases, at the gNB side, the final PMI may be obtained based on the reported layers, and the reported soft RI (probability of each rank or layer) can be considered a form of assistance information for scheduling and user pairing.

The fractional rank indication and adaptive quantization signaling mechanisms described herein may be applied to A1 based CSI feedback and non-AI based CSI feedback (e.g., reporting Tx covariance informations, such as singular vectors and singular values).

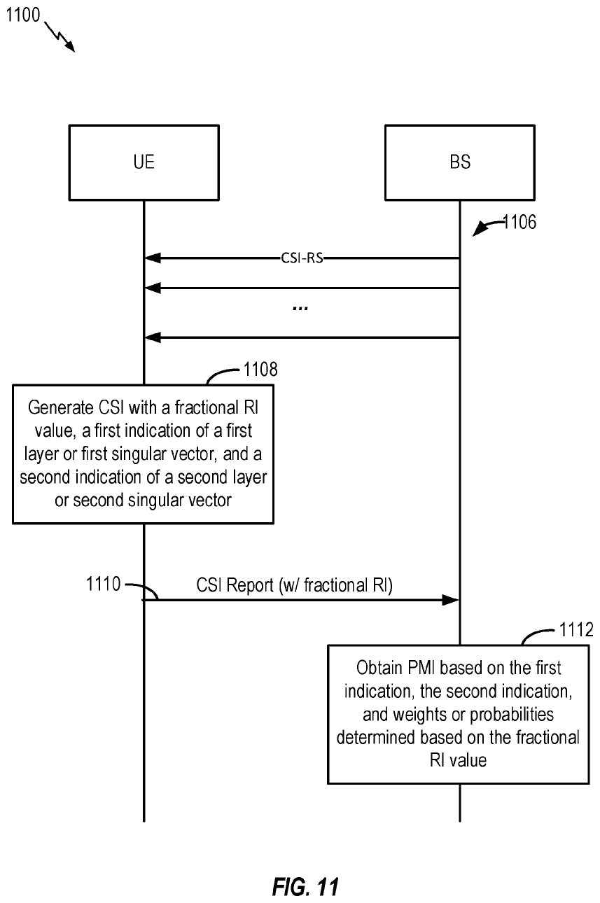

The signaling mechanism proposed herein may be understood with reference to the call flow diagram 1100 of FIG. 11.

As illustrated, the BS may transmit CSI-RS, at 1106. Based on the CSI-RS, at 1108, the UE generates CSI with a fractional RI value, a first indication of a first layer or first singular vector, and a second indication of a second layer or second singular vector. At 1110, the UE transmits the CSI, with the fractional RI, first indication, and second indication, to the BS. At 1112, the BS obtains PMI based on the first indication, the second indication, and weights or probabilities determined based on the fractional RI value.

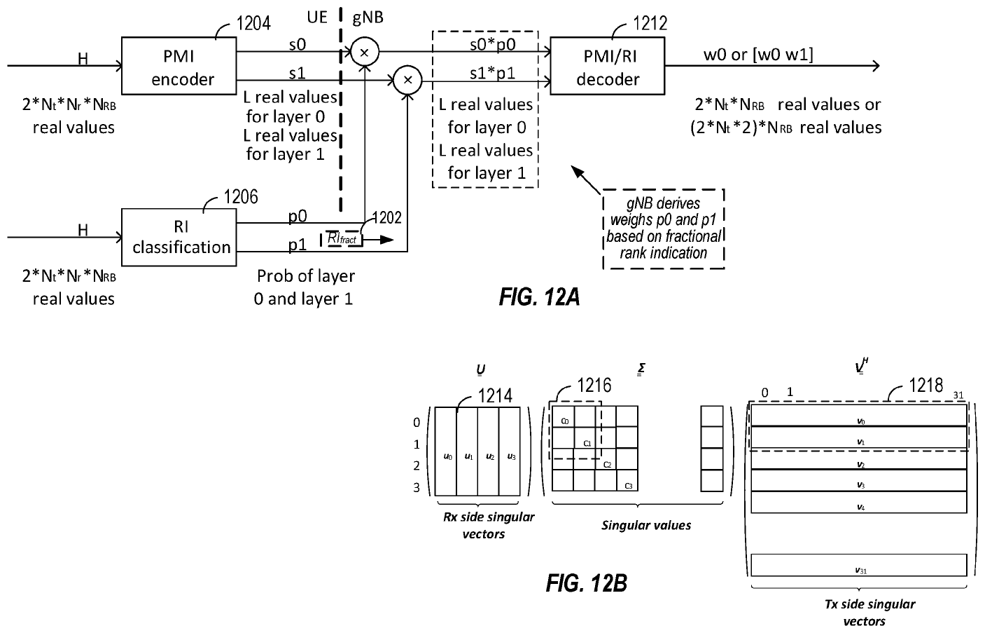

As illustrated in FIG. 12A, for an ML-based approach, the PMI encoder 1204 and RI classification block 1206 may perform as the PMI encoder 1004 and RI classification block 1006 described above, with reference to FIG. 10A. In this case, however, at the UE side, a fractional RI value 1202 may be generated. An ouput of a last module of the RI classification block 1206 may be a softmax value. The fractional RI value 1202 may be generated based on the outcome of the RI classification block 1206 and sent (e.g., in a CSI report) along with the first indication of the first layer/singular vector s0 and the second indication of the second layer/singular vector s1.

At the gNB side, the gNB may derive the first layer/singular vector s0 from the first indication and the second layer/singular vector s1 from the first and second indications. As indicated, the gNB may also derive p0 and p1 based on the fractional RI value 1202. The gNB may then take the products of s0*p0 and s1*p1 as the input to PMI/RI decoder 1212. Alternatively, the gNB may take the s0, s1 and p0 and p1 as input to the PMI/RI decoder 1212.

For a non-ML based approach, the UE may report Tx covariance information, such as singular vectors 1218 and singular values 1216, as shown in FIG. 12B. As noted above, given this information, the gNB may be able to obtain the transmit side covariance information, e.g., [c0*v0, c*v1, . . . ].

There are various options for exactly what the fractional RI value may indicate and how. For example, according to a first option, the UE reports a single fractional RI value of a certain size. For example, the RI value may be a codepoint of log 2(N_frac_RI) bits. In some cases, the codepoint may correspond to either an integer rank or a fractional rank, and N_frac_RI is the total number of candidate ranks (e.g., including both integer rank and fractional rank). For example, the candidate ranks may be: {1, 1.5, 1.75, 2} or {1, 1.5, 2, 2.5, 3, 3.5, 4}. In some cases, the codepoint may correspond to a condition number of the channel estimates (corresponding to each rank). For example, the condition number (cond) may be calculated as:

cond=sigma_max/sigma_min,

where sigma_max and sigma_min are the largest and smallest singular values of the channel estimates.
According to a second option, the ULE reports a probability of each rank. For example, the UE may report a single value of log 2(N_frac_rank_profile) bits, wherein a codepoint corresponds to a probability profile of all ranks, meaning the single value takes into account the collective probabilities of reach rank. For example, the single value may indicate a probability profile of: {p1, p2, p3, p4} where p1+p2+p3+p4=1 or {p1, p2} where p1+p2=1.

In some cases, the UE may report a probability per rank. For example, the UE may report probability p_i for rank-i separately using log 2(N) bits per rank, such that a total of log 2(N)×(max_rank−1) bits are reported. In this case, assuming the probabilities sum to 1, the probability of the last rank (e.g., rank=max_rank) may be given by 1−sum(p_1, . . . p_{max_rank−1}) so the probability for this rank does not need to be explicitly reported.

In some cases, the UE may report a condition number cond_i for rank-i using log(N) bits. For example, the UE may report cond_i=sigma_max/sigma_i, where sigma_max is the largest singular value, and signma_i is i-th largest singular value of the channel estimates. In this case, the UE need not report cond_1 (e.g., because sigma_max/sigm_max=cond_1=1).

In either of these cases, where the UE reports a probability of each rank, the weight applied to layer i may be the sum(p_i,p_{i+1}, . . . , p_{max_rank}).

According to a third option, the UE may report a weight of each layer. For example, the UE may report a single value of log 2(N_frac_layer_profile) bits, wherein a codepoint corresponds to a weight profile of all layers. This may be similar to the second option above for reporting a probability of each rank, but the summation of the weights of each layer may not be 1.

In other cases, the UE may report the weight of each layer separately. For example, assuming the weight of layer 1 is 1, the UE may report the weight for layer-i using log 2(N) bits, for a total of log 2(N)×(max_rank−1) bits. The weight of layer-i can be the ratio between the i-th largest singular value of the channel estimates and the largest singular value (i.e., weight_i=sigma_i/sigma_max).

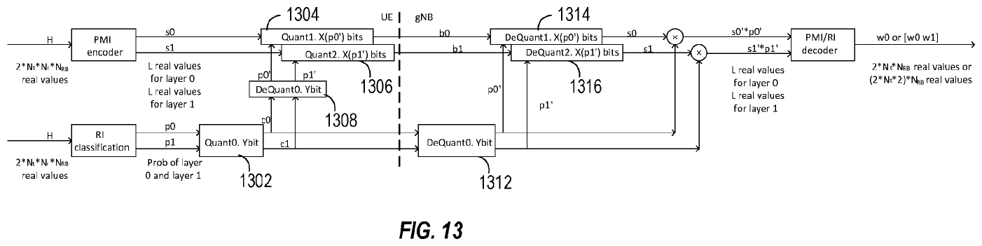

As noted above, aspects of the present disclosure also provide for adaptation of the quantization resolution, in cases where quantization is used. For example, as illustrated in FIG. 13, in some case, the quantization resolution of layer-i may be based on the fractional rank. In the illustrated example, the probability of each layer, p0 and p1, may be quantized (by quantization block 1302) to obtain values c0 and c1. In order to ensure the gNB is able to determine the quantization resolution, the values c0 and c1 may be de-quantized (by dequantization block 1308), to obtain values p0′ and p1′.

As illustrated, when quantizing layer 0 (s0) with quantization block 1304, the quantization resolution, in terms of bits, may depend on p0′, the probability of rank-1 or weight of layer-1: X0(p0′), derived from the fractional rank indication, resulting in a quantized value b0 of X0(p0′) bits. Similarly, when quantizing layer 1 (s1) with quantization block 1306, the quantization resolution, in terms of bits, may depend on p1′, the probability of rank-1 or weight of layer-1: X1(p1′), derived from the fractional rank indication, resulting in a quantized value b1 of X1(p1′) bits. Quantization blocks 1304/1306 may generally determine a higher quantization resolution for a layer with higher probability, and a lower resolution for a layer with lower probability (and output a number of quantized bits accordingly).

At the gNB side, the fractional rank indication may also be used to obtain p0‘and p1’ via a dequantization block 1312. Given p0′ and p1′, the gNB knows the quantization resolution used at the ULE and can input p0‘ and p1’ into dequantization logic 1314 and 1316 to dequantize layer 0 value b0 and layer 1 value b1. Finally, the gNB can use the products s0′*p0′ and s1′ *p1′ to construct the PMI (e.g., w0 or w0 and w1).

Given the potential for quantization resolutions to be different, the alphabet used for each layer can be same or different. In some cases, if the same alphabet is used, a full alphabet may be used for X0(p0′) bits quantization for layer 0, while a subset of the alphabet is used for X1(p1′) bits quantization for layer 1. In a more general case, if a first layer has a larger probability than a second layer, the size of the alphabet applied to the first layer may be larger than the size of the alphabet applied to the second layer. Sometimes these alphabets may be subsets from a total alphabet for all layers.

In some cases, the fractional rank indication may be reported in a first CSI part (e.g., CSI part 1), while the actual quantization values of each layer may be reported in a second part (e.g., CSI part2). In such cases, the actual payload size of the second CSI part (e.g., CSI part 2) may depend on the fractional rank reported in CSI part 1. Example Methods

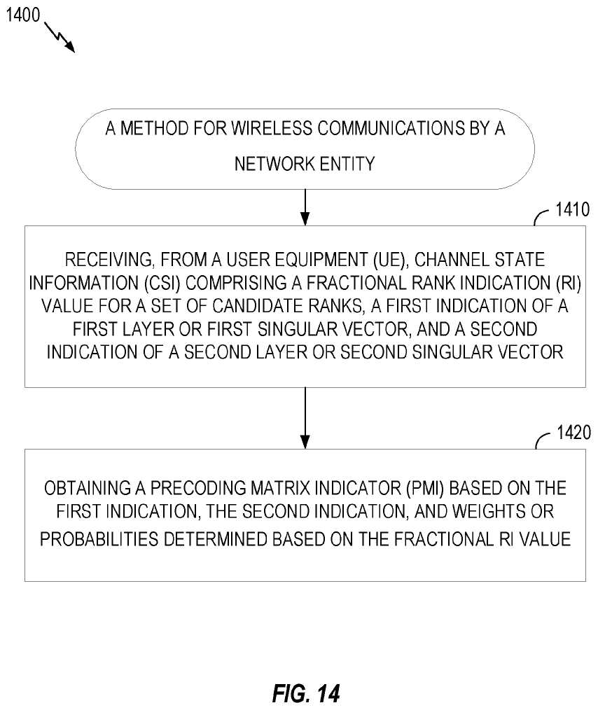

FIG. 14 is a flow diagram illustrating example operations 1400 for wireless communication by a UE, in accordance with certain aspects of the present disclosure. The operations 1400 may be performed, for example, by a UE (e.g., such as the UE 104 illustrated in FIGS. 1 and 2). The operations 1400 may be implemented as software components that are executed and run on one or more processors (e.g., controller/processor 280 of FIG. 2). Further, the transmission and reception of signals by the BS in operations 1400 may be enabled, for example, by one or more antennas (e.g., antennas 252 of FIG. 2). In certain aspects, the transmission and/or reception of signals by the BS may be implemented via a bus interface of one or more processors (e.g., controller/processor 280) obtaining and/or outputting signals.

Operations 1400 begin, at 1410, by generating channel state information (CSI) comprising a (at least one) fractional rank indication (RI) value for a set of candidate ranks, a first indication of a first layer or first singular vector, and a second indication of a second layer or second singular vector. At 1420, the UE transmits the CSI to a network entity.

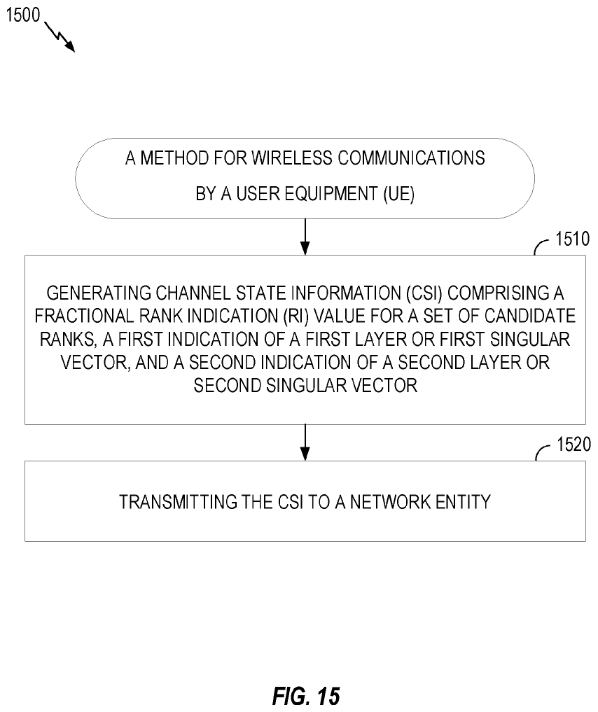

FIG. 15 is a flow diagram illustrating example operations 1500 for wireless communication by a network entity, in accordance with certain aspects of the present disclosure. The operations 1500 may be performed, for example, by a BS (e.g., such as the BS 102 illustrated in FIGS. 1 and 2). The operations 1500 may be implemented as software components that are executed and run on one or more processors (e.g., controller/processor 240 of FIG. 2). Further, the transmission and reception of signals by the BS in operations 1500 may be enabled, for example, by one or more antennas (e.g., antennas 234 of FIG. 2). In certain aspects, the transmission and/or reception of signals by the UE may be implemented via a bus interface of one or more processors (e.g., controller/processor 240) obtaining and/or outputting signals.

The operations 1500 may begin, at a first block 1510, by receiving, from a UE, channel state information (CSI) comprising a (at least one) fractional rank indication (RI) value for a set of candidate ranks, a first indication of a first layer or first singular vector, and a second indication of a second layer or second singular vector. At 1520, the transmit node obtains a precoding matrix indicator (PMI) based on the first indication, the second indication, and weights or probabilities determined based on the fractional RI value.

### Example Wireless Communication Devices

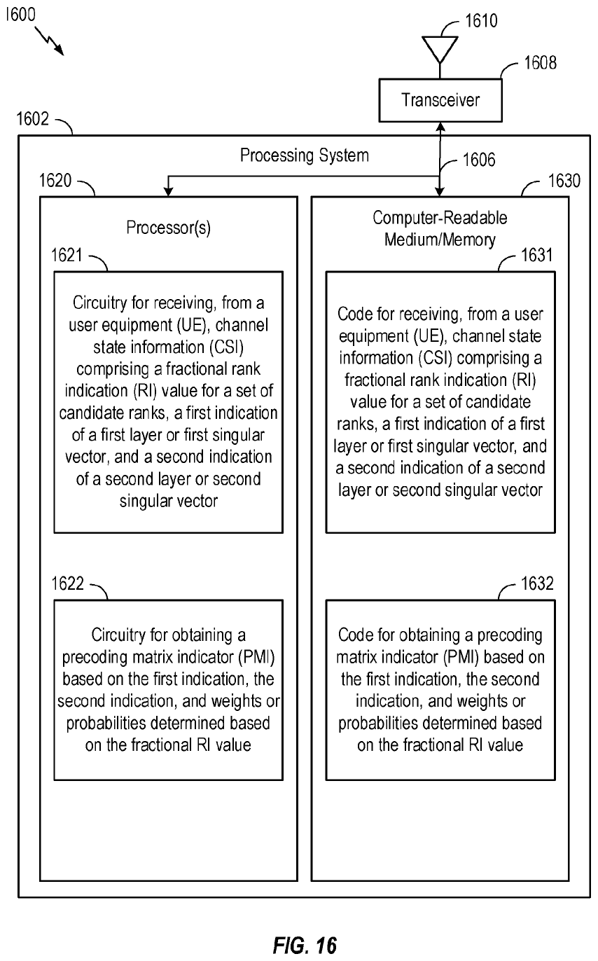

FIG. 16 depicts an example communication device 1600 that includes various components operable, configured, or adapted to perform operations for the techniques disclosed herein, such as the operations depicted and described with respect to FIG. 14. In some examples, communication device 1600 may be a user equipment 104 as described, for example with respect to FIGS. 1 and 2.

Communication device 1600 includes a processing system 1602 coupled to a transceiver 1608 (e.g., a transmitter and/or a receiver). Transceiver 1608 is configured to transmit (or send) and receive signals for the communication device 1600 via an antenna 1610, such as the various signals as described herein. Processing system 1602 may be configured to perform processing functions for communication device 1600, including processing signals received and/or to be transmitted by communication device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIG. 14, or other operations for performing the various techniques discussed herein for participate in a CSF procedure.

In the depicted example, computer-readable medium/memory 1630 stores code 1631 for generating channel state information (CSI) comprising a (at least one) fractional rank indication (RI) value for a set of candidate ranks, a first indication of a first layer or first singular vector, and a second indication of a second layer or second singular vector and code 1632 for transmitting the CSI to a network entity.

In the depicted example, the one or more processors 1620 include circuitry configured to implement the code stored in the computer-readable medium/memory 1630, including circuitry 1621 for generating channel state information (CSI) comprising a (at least one) fractional rank indication (RI) value for a set of candidate ranks, a first indication of a first layer or first singular vector, and a second indication of a second layer or second singular vector and circuitry 1622 for transmitting the CSI to a network entity.

Various components of communication device 1600 may provide means for performing the methods described herein, including with respect to FIG. 14.

In some examples, means for transmitting or sending (or means for outputting for transmission) may include the transceivers 254 and/or antenna(s) 252 of the user equipment 104 illustrated in FIG. 2 and/or transceiver 1608 and antenna 1610 of the communication device 1600 in FIG. 16.

In some examples, means for receiving (or means for obtaining) may include the transceivers 254 and/or antenna(s) 252 of the user equipment 104 illustrated in FIG. 2 and/or transceiver 1608 and antenna 1610 of the communication device 1600 in FIG. 16.

In some examples, means for generating and/or means for transmitting may include various processing system components, such as: the one or more processors 1620 in FIG. 16, or aspects of the user equipment 104 depicted in FIG. 2, including receive processor 258, transmit processor 264, TX MIMO processor 266, and/or controller/processor 280 (including CSI Component 281).

Notably, FIG. 16 is an example, and many other examples and configurations of communication device 1600 are possible.

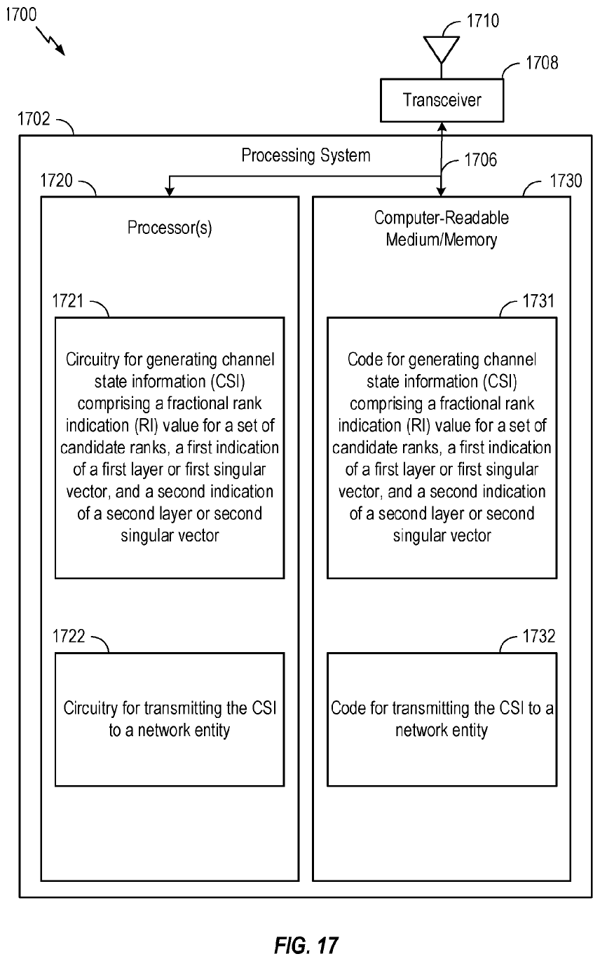

FIG. 17 depicts an example communication device 1700 that includes various components operable, configured, or adapted to perform operations for the techniques disclosed herein, such as the operations depicted and described with respect to FIG. 15. In some examples, communication device 1700 may be a base station 102 as described, for example with respect to FIGS. 1 and 2.

Communication device 1700 includes a processing system 1702 coupled to a transceiver 1708 (e.g., a transmitter and/or a receiver). Transceiver 1708 is configured to transmit (or send) and receive signals for the communication device 1700 via an antenna 1710, such as the various signals as described herein. Processing system 1702 may be configured to perform processing functions for communication device 1700, including processing signals received and/or to be transmitted by communication device 1700.

Processing system 1702 includes one or more processors 1720 coupled to a computer-readable medium/memory 1730 via a bus 1706. In certain aspects, computer-readable medium/memory 1730 is configured to store instructions (e.g., computer-executable code) that when executed by the one or more processors 1720, cause the one or more processors 1720 to perform the operations illustrated in FIG. 15, or other operations for performing the various techniques discussed herein for participate in a CSF procedure.

In the depicted example, computer-readable medium/memory 1730 stores code 1731 for receiving, from a user equipment (UE), channel state information (CSI) comprising a (at least one) fractional rank indication (RI) value for a set of candidate ranks, a first indication of a first layer or first singular vector, and a second indication of a second layer or second singular vector and code 1732 for obtaining a precoding matrix indicator (PMI) based on the first indication, the second indication, and weights or probabilities determined based on the fractional RI value.

In the depicted example, the one or more processors 1720 include circuitry configured to implement the code stored in the computer-readable medium/memory 1730, including circuitry 1721 for receiving, from a user equipment (UE), channel state information (CSI) comprising a (at least one) fractional rank indication (RI) value for a set of candidate ranks, a first indication of a first layer or first singular vector, and a second indication of a second layer or second singular vector and circuitry 1722 for obtaining a precoding matrix indicator (PI) based on the first indication, the second indication, and weights or probabilities determined based on the fractional RI value.

Various components of communication device 1700 may provide means for performing the methods described herein, including with respect to FIG. 15.

In some examples, means for transmitting or sending (or means for outputting for transmission) may include the transceivers 232 and/or antenna(s) 234 of the base station 102 illustrated in FIG. 2 and/or transceiver 1708 and antenna 1710 of the communication device 1700 in FIG. 17.

In some examples, means for receiving (or means for obtaining) may include the transceivers 232 and/or antenna(s) 234 of the base station illustrated in FIG. 2 and/or transceiver 1708 and antenna 1710 of the communication device 1700 in FIG. 17.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving and/or obtaining may include various processing system components, such as: the one or more processors 1720 in FIG. 17, or aspects of the base station 102 depicted in FIG. 2, including receive processor 238, transmit processor 220, TX MIMO processor 230, and/or controller/processor 240 (including CSI component 241).

Notably, FIG. 17 is an example, and many other examples and configurations of communication device 1700 are possible.

### Example Clauses

Implementation examples are described in the following numbered clauses:

Clause 1: A method for wireless communications by a user equipment (UE), comprising: generating channel state information (CSI) comprising a fractional rank indication (RI) value for a set of candidate ranks, a first indication of a first layer or first singular vector, and a second indication of a second layer or second singular vector; and transmitting the CSI to a network entity.

Clause 2: The method of Clause 1, further comprising: deriving weights or probabilities for the first and second layers or first and second singular vectors; and selecting the fractional RI value as an indication of the weights or probabilities.

Clause 3: The method of Clause 2, comprising: deriving the first and second indications using a precoding matrix indicator (PMI) encoder; and deriving the probabilities using an RI classification module.

Clause 4: The method of any one of Clauses 1-, wherein the fractional RI value indicates a codepoint corresponding to a candidate rank of the set of candidate ranks, wherein the candidate rank is a fractional rank value or an integer rank value.

Clause 5: The method of any one of Clauses 1-, wherein the fractional RI value indicates a codepoint corresponding to a condition number based on singular values of channel estimates.

Clause 6: The method of any one of Clauses 1-, wherein the fractional RI value indicates a codepoint corresponding to a probability profile of the set of candidate ranks.

Clause 7: The method of any one of Clauses 1-, wherein the fractional RI value indicates separate probabilities for different candidate ranks in the set of candidate ranks.

Clause 8: The method of Clause 7, wherein, for each candidate rank, a probability of that candidate rank represents a ratio between a maximum eigenvalue and a minimum eigenvalue for layers of that candidate rank.

Clause 9: The method of any one of Clauses 1-, wherein the fractional RI value indicates a codepoint corresponding to a weight or probability profile of a set of layers corresponding to the set of candidate ranks.

Clause 10: The method of any one of Clauses 1-, wherein the fractional RI value indicates separate weights or probabilities for each of a set of layers corresponding to the set of candidate ranks.

Clause 11: The method of any one of Clauses 1-, further comprising: determining quantization resolutions for the first and second indications based on the fractional RI value.

Clause 12: The method of Clause 11, wherein determining the quantization resolutions for the first and second indications comprises: determining a first number of bits for the first indication based on a probability of a first candidate rank or weight of the first layer; and determining a second number of bits for the second indication based on a probability of a second candidate rank or weight of the second layer.

Clause 13: The method of Clause 12, comprising: using a first subset of an alphabet for the first number of bits; and using a second subset of the alphabet for the second number of bits, wherein a first size of the first subset is determined based on the probability of the first candidate rank or weight of the first layer and a second size of the second subset is determined based on the probability of the second candidate rank or weight of the second layer.

Clause 14: The method of Clause 13, wherein the first subset is larger than the second subset when the probability of the first candidate rank or weight of the first layer is larger than the probability of the second candidate rank or weight of the second layer.

Clause 15: The method of Clause 11, comprising: reporting the fractional RI value in a first CSI part; and reporting quantized values of the first and second indication are reported in a second CSI part, wherein an actual payload of the second CSI part depends on the fractional RI value reported in the first CSI part.

Clause 16: A method for wireless communications by a network entity, comprising: receiving, from a user equipment (ULE), channel state information (CSI) comprising a fractional rank indication (RI) value for a set of candidate ranks, a first indication of a first layer or first singular vector, and a second indication of a second layer or second singular vector; and obtaining a precoding matrix indicator (PMI) based on the first indication, the second indication, and weights or probabilities determined based on the fractional RI value.

Clause 17: The method of Clause 16, wherein the PMI is obtained based on: a first product of a first weight or probability and the first layer or singular vector; and a second product of a second weight or probability and the second layer or singular vector.

Clause 18: The method of any one of Clauses 16-17, comprising: obtaining the PMI using a precoding matrix indicator (PMI) decoder which takes the fractional RI value and first and second indications as input.

Clause 19: The method of any one of Clauses 16-18, comprising: obtaining the PMI based on a first product of a first weight and a first layer or singular vector, and a second product of a second weight and second layer or singular vector, wherein the first weight and second weight are determined based on the fractional rank indication.

Clause 20: The method of any one of Clauses 16-19, wherein the fractional RI value indicates a codepoint corresponding to a candidate rank of the set of candidate ranks, wherein a candidate rank is a fractional rank value or an integer rank value.

Clause 21: The method of any one of Clauses 16-20, wherein the fractional RI value indicates a codepoint corresponding to a condition number based on singular values of channel estimates.

Clause 22: The method of any one of Clauses 16-21, wherein the fractional RI value indicates a codepoint corresponding to a probability profile of the set of candidate ranks.

Clause 23: The method of any one of Clauses 16-22, wherein the fractional RI value indicates separate probabilities for different candidate ranks in the set of candidate ranks.

Clause 24: The method of Clause 23, wherein for each candidate rank, a probability of that candidate rank represents a ratio between a maximum eigenvalue and a minimum eigenvalue for layers of that candidate rank.

Clause 25: The method of any one of Clauses 16-24, wherein the fractional RI value indicates a codepoint corresponding to a weight or probability profile of a set of layers corresponding to the set of candidate ranks, wherein a number of layers is based on a configured max possible rank.

Clause 26: The method of any one of Clauses 16-25, wherein the fractional RI value indicates separate weights or probabilities for each of a set of layers corresponding to the set of candidate ranks.

Clause 27: The method of any one of Clauses 16-26, further comprising: determining quantization resolutions for the first and second indications, based on the fractional RI value; and interpreting the first and second indications based on the quantization resolutions.

Clause 28: The method of Clause 27, wherein determining quantization resolutions for the first and second indications comprises: determining a first number of bits for the first indication based on a probability of a first candidate rank or weight of a first layer; and determining a second number of bits for the second indication based on a probability of a second candidate rank or weight of a second layer.

Clause 29: The method of Clause 27, wherein, if a same alphabet is used for each layer corresponding to the candidate ranks, a first subset of the alphabet is used for the first number of bits and a second subset of the alphabet is used for the second number of bits, wherein the size of the first and second alphabets are determined based on the probability of the first candidate rank or weight of the first layer or probability of the second candidate rank or weight of the second layer, respectively.

Clause 30: The method of Clause 29, wherein the first subset is larger than the second subset when the probability of the first candidate rank or weight of the first layer is larger than the probability of the second candidate rank or weight of the second layer.

Clause 31: The method of Clause 27, wherein: the at least one fractional RI value is received in a first channel state information (CSI) part; quantized values of the first and second indication are received in a second CSI part; and an actual payload of the second CSI part depends on the at least one fractional RI value reported in the first CSI part.

Clause 32: An apparatus, comprising: a memory comprising executable instructions; one or more processors configured to execute the executable instructions and cause the apparatus to perform a method in accordance with any one of Clauses 1-31.

Clause 33: An apparatus, comprising means for performing a method in accordance with any one of Clauses 1-31.

Clause 34: A non-transitory computer-readable medium comprising executable instructions that, when executed by one or more processors of an apparatus, cause the apparatus to perform a method in accordance with any one of Clauses 1-31.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### ADDITIONAL CONSIDERATIONS

The preceding description provides examples of beam refinement procedures in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a user equipment (UE), comprising:
generating channel state information (CSI) comprising a fractional rank indication (RI) value for a set of candidate ranks, a first indication of a first layer or first singular vector, and a second indication of a second layer or second singular vector; and
transmitting the CSI to a network entity.

2. The method of claim 1, further comprising:
deriving weights or probabilities for the first and second layers or first and second singular vectors; and
selecting the fractional RI value as an indication of the weights or probabilities.

3. The method of claim 2, comprising:
deriving the first and second indications using a precoding matrix indicator (PMI) encoder; and
deriving the probabilities using an RI classification module.

4. The method of claim 1, wherein the fractional RI value indicates a codepoint corresponding to a candidate rank of the set of candidate ranks, wherein the candidate rank is a fractional rank value or an integer rank value.

5. The method of claim 1, wherein the fractional RI value indicates a codepoint corresponding to a condition number based on singular values of channel estimates.

6. The method of claim 1, wherein the fractional RI value indicates a codepoint corresponding to a probability profile of the set of candidate ranks.

7. The method of claim 1, wherein the fractional RI value indicates separate probabilities for different candidate ranks in the set of candidate ranks.

8. The method of claim 7, wherein, for each candidate rank, a probability of that candidate rank represents a ratio between a maximum eigenvalue and a minimum eigenvalue for layers of that candidate rank.

9. The method of claim 1, wherein the fractional RI value indicates a codepoint corresponding to a weight or probability profile of a set of layers corresponding to the set of candidate ranks.

10. The method of claim 1, wherein the fractional RI value indicates separate weights or probabilities for each of a set of layers corresponding to the set of candidate ranks.

11. The method of claim 1, further comprising: determining quantization resolutions for the first and second indications based on the fractional RI value.

12. The method of claim 11, wherein determining the quantization resolutions for the first and second indications comprises:
determining a first number of bits for the first indication based on a probability of a first candidate rank or weight of the first layer; and
determining a second number of bits for the second indication based on a probability of a second candidate rank or weight of the second layer.

13. The method of claim 12, comprising:
using a first subset of an alphabet for the first number of bits; and
using a second subset of the alphabet for the second number of bits, wherein a first size of the first subset is determined based on the probability of the first candidate rank or weight of the first layer and a second size of the second subset is determined based on the probability of the second candidate rank or weight of the second layer.

14. The method of claim 13, wherein the first subset is larger than the second subset when the probability of the first candidate rank or weight of the first layer is larger than the probability of the second candidate rank or weight of the second layer.

15. The method of claim 11, comprising:
reporting the fractional RI value in a first CSI part; and
reporting quantized values of the first and second indication are reported in a second CSI part, wherein an actual payload of the second CSI part depends on the fractional RI value reported in the first CSI part.

16. A method for wireless communications by a network entity, comprising:
receiving, from a user equipment (UE), channel state information (CSI) comprising a fractional rank indication (RI) value for a set of candidate ranks, a first indication of a first layer or first singular vector, and a second indication of a second layer or second singular vector; and
obtaining a precoding matrix indicator (PMI) based on the first indication, the second indication, and weights or probabilities determined based on the fractional RI value.

17. The method of claim 16, wherein the PMI is obtained based on:
a first product of a first weight or probability and the first layer or singular vector; and
a second product of a second weight or probability and the second layer or singular vector.

18. The method of claim 16, comprising:
obtaining the PMI using a precoding matrix indicator (PI) decoder which takes the fractional RI value and first and second indications as input.

19. The method of claim 16, comprising:
obtaining the PMI based on a first product of a first weight and a first layer or singular vector, and a second product of a second weight and second layer or singular vector, wherein the first weight and second weight are determined based on the fractional rank indication.

20. The method of claim 16, wherein the fractional RI value indicates a codepoint corresponding to a candidate rank of the set of candidate ranks, wherein a candidate rank is a fractional rank value or an integer rank value.

21. The method of claim 16, wherein the fractional RI value indicates a codepoint corresponding to a condition number based on singular values of channel estimates.

22. The method of claim 16, wherein the fractional RI value indicates a codepoint corresponding to a probability profile of the set of candidate ranks.

23. The method of claim 16, wherein the fractional RI value indicates separate probabilities for different candidate ranks in the set of candidate ranks.

24. The method of claim 23, wherein for each candidate rank, a probability of that candidate rank represents a ratio between a maximum eigenvalue and a minimum eigenvalue for layers of that candidate rank.

25. The method of claim 16, wherein the fractional RI value indicates a codepoint corresponding to a weight or probability profile of a set of layers corresponding to the set of candidate ranks, wherein a number of layers is based on a configured max possible rank.

26. The method of claim 16, wherein the fractional RI value indicates separate weights or probabilities for each of a set of layers corresponding to the set of candidate ranks.

27. The method of claim 16, further comprising:
determining quantization resolutions for the first and second indications, based on the fractional RI value; and
interpreting the first and second indications based on the quantization resolutions.

28. The method of claim 27, wherein determining quantization resolutions for the first and second indications comprises:
determining a first number of bits for the first indication based on a probability of a first candidate rank or weight of a first layer; and
determining a second number of bits for the second indication based on a probability of a second candidate rank or weight of a second layer.

29. An apparatus, comprising:
a memory comprising executable instructions; and
one or more processors configured to execute the executable instructions and cause the apparatus to
generate channel state information (CSI) comprising a fractional rank indication (RI) value for a set of candidate ranks, a first indication of a first layer or first singular vector, and a second indication of a second layer or second singular vector; and
transmit the CSI to a network entity.

30. A non-transitory computer-readable medium for wireless communication, comprising:
executable instructions that, when executed by one or more processors of an apparatus, cause the apparatus to:
generate channel state information (CSI) comprising a fractional rank indication (RI) value for a set of candidate ranks, a first indication of a first layer or first singular vector, and a second indication of a second layer or second singular vector; and
transmit the CSI to a network entity.
